(19) United States
(12) Patent Application Publication
(10) Pub. No.: US 2025/0265771 A1
(43) Pub. Date: Aug. 21, 2025

(54) EXTENDED REALITY DEVICE SUPPORTING LOW POWER-BASED IMAGE SIGNAL PROCESSING AND METHOD OF OPERATING THE SAME

(71) Applicant: SAMSUNG ELECTRONICS CO., LTD., Suwon-si (KR)

(72) Inventors: Seunghun Kim, Suwon-si (KR); Taekkyun Shin, Suwon-si (KR); Junhee Yoo, Suwon-si (KR); Sungwon Lee, Suwon-si (KR)

(21) Appl. No.: 18/932,205

(22) Filed: Oct. 30, 2024

(30) Foreign Application Priority Data
Feb. 16, 2024 (KR) 10-2024-0022674

(51) Int. Cl. G06T 15/40

(52) U.S. Cl. CPC G06T 15/40

(57) ABSTRACT

A method of operating an extended reality (XR) device includes generating a first display picture in a first frame duration, and generating a second display picture in a second frame duration. Generating the first display picture includes generating first invisible portion information by determining a first invisible portion of a first real image based on a first graphic object image, performing first image signal processing on first sensing data of a first image signal based on the first invisible portion information, and generating the first display picture based on the processed first sensing data and the first graphic object image.

### CROSS-REFERENCE TO RELATED APPLICATION

This application claims priority under 35 U.S.C. § 119 to Korean Patent Application No. 10-2024-0022674, filed on Feb. 16, 2024, in the Korean Intellectual Property Office, the disclosure of which is incorporated by reference herein in its entirety.

### BACKGROUND

In an extended reality (XR) device, a real image captured by a camera is composited with a virtual image through a plurality of processors included in the XR device and provided to a user as a display picture.

Generally, in the XR device, the real image must be prepared intact without considering being obscured by the virtual image because the time point at which the virtual image and the real image are composited is just before providing the display picture to the user. Therefore, to generate the real image in the XR device, processing must be performed uniformly on all image signals generated from the camera. The processing on all the image signals may cause inefficient power consumption of the XR device.

### SUMMARY

The disclosure provides an extended reality (XR) device that effectively performs low power-based image signal processing and a method of operating the same.

According to an aspect of the disclosure, there is provided a method of operating an XR device, the method including generating a first display picture in a first frame duration, and generating a second display picture in a second frame duration, wherein the generating of the first display picture includes generating first invisible portion information by determining a first invisible portion of a first real image based on a first graphic object image, performing first image signal processing on first sensing data of a first image signal based on the first invisible portion information, and generating the first display picture based on the processed first sensing data and the first graphic object image.

According to another aspect of the disclosure, there is provided an XR device including a first processor configured to generate a first graphic object image in a first frame duration, a second processor configured to perform, based on first invisible portion information indicating a first invisible portion of a first real image obscured by the first graphic object image, first image signal processing on other sensing data than sensing data corresponding to the first invisible portion among first sensing data of a first image signal in the first frame duration, and a third processor configured to generate a display picture based on the first graphic object image and processed sensing data in the first frame duration.

According to another aspect of the disclosure, there is provided a method of operating an XR device, the method including determining an invisible portion of a real image obscured by a graphic object image, performing image signal processing on other sensing data than sensing data corresponding to the invisible portion among sensing data of an image signal, and generating a display picture based on the processed sensing data and the graphic object image.

### BRIEF DESCRIPTION OF THE DRAWINGS

Embodiments will be more clearly understood from the following detailed description taken in conjunction with the accompanying drawings in which:

FIG. 1 is a diagram of a schematic configuration of an extended reality (XR) device according to some embodiments;

FIG. 2 is a flowchart of a method of operating an XR device according to some embodiments;

FIG. 3 is a schematic block diagram of an XR device according to some embodiments;

FIG. 4 is a diagram explaining an operation of an XR device according to some embodiments;

FIG. 5 is a diagram explaining invisible portion information according to some embodiments;

FIGS. 6A and 6B are diagrams explaining an image signal processing method according to some embodiments and FIG. 6C is a schematic block diagram of an image signal processor that performs the method of FIGS. 6A and 6B;

FIGS. 7A and 7B are diagrams explaining invisible area filters used in image signal processing according to some embodiments and FIG. 7C is a schematic block diagram of an image signal processor using the invisible area filters of FIGS. 7A and 7B;

FIG. 8 is a flowchart of a method of operating a central processing unit (CPU) according to some embodiments;

FIGS. 9A and 9B are diagrams explaining an operation of an XR device according to some embodiments;

FIG. 10 is a flowchart of a method of operating a CPU according to some embodiments;

FIG. 11 is a diagram explaining an operation of an XR device according to some embodiments;

FIGS. 12A and 12B are schematic block diagrams of an XR device according to some embodiments;

FIG. 13 is a flowchart of a method of operating an XR device according to some embodiments;

FIG. 14A is a flowchart of a method of operating an XR device according to some embodiments and FIG. 14B is a diagram specifically explaining FIG. 14A;

FIG. 15 is a flowchart of a method of correcting invisible portion information of a CPU according to some embodiments;

FIGS. 16A and 16B are diagrams explaining invisible portion information corrected according to the method described with reference to FIG. 15;

FIG. 17A is a block diagram of an invisible portion decision circuit according to some embodiments and FIG. 17B is a flowchart of a method of learning an invisible pixel decision logic of FIG. 17A; and

FIG. 18 is a conceptual diagram of an Internet of Things (IoT) network system to which embodiments are applied.

### DETAILED DESCRIPTION

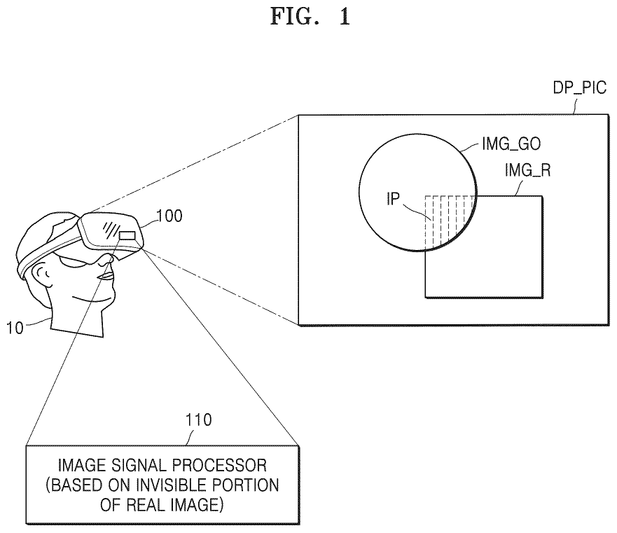

FIG. 1 is a diagram of a schematic configuration of an extended reality (XR) device according to some embodiments.

Referring to FIG. 1, an XR device 100 includes an image signal processor 110 that performs image signal processing based on an invisible portion of a real image. As used herein, performing processing may also be referred to as performing a processing operation. The extended reality may include virtual reality (VR), augmented reality (AR), and mixed reality (MR). VR technology may provide objects and backgrounds in the real world as computer graphics (CG) pictures, AR technology may provide virtual CG pictures on top of pictures of real objects, and MR technology may provide pictures that combine virtual objects with the real world. As the VR technology, the AR technology, and the MR technology are computer graphics technologies, the disclosure may be applied to the VR technology, the AR technology, and the MR technology. XR technology to be described below may be understood as a concept encompassing the VR technology, the AR technology, and the MR technology.

The XR technology according to the disclosure may be applied to head-mounted displays (HMDs), head-up displays (HUDs), mobile phones, tablet personal computers (PCs), desktops, TVs, digital signage, and the like, wherein a device to which the XR technology is applied may be referred to as the XR device 100. In FIG. 1, although the description is centered on some embodiments of the XR device 100 implemented as an HMD worn by a user 10, it will be fully understood that this is only an example and the disclosure is not limited thereto.

According to some embodiments, the image signal processor 110 may perform image signal processing on a display picture DP_PIC considering an invisible portion IP of a real image IMG_R which is obscured by a graphic object image IMG_GO. Herein, the display picture DP_PIC may be defined as a picture output to the user 10 through a display device included in the XR device 100, the graphic object image IMG_GO, which is a virtual object shown to the user 10 based on an application executed by the user 10, may be defined as an image generated by a graphics processing unit (GPU) to be described below, and the real image IMG_R, which is a real background or an object captured by a camera included in the XR device 100, may be defined as an image generated by the image signal processor 110. In FIG. 1, some embodiments including one graphic object image IMG_GO and one real image IMG_R is shown, but this is only an example and is not limited thereto. It will be fully understood that the disclosure can be applied to a plurality of graphic object images and a plurality of real images.

According to some embodiments, the image signal processor 110 may perform image signal processing on other sensing data than sensing data corresponding to the invisible portion IP among sensing data of an image signal received from the camera. That is, the camera may include a plurality of image sensors and may provide sensing data as an image signal to the image signal processor 110 through the plurality of image sensors. The sensing data of the image signal may include the sensing data corresponding to the invisible portion IP.

According to some embodiments, the XR device 100 may further include a central processing unit (CPU) that generates invisible portion information indicating the invisible portion IP to support the image signal processing considering the invisible portion IP of the image signal processor 110. According to some embodiments, the CPU may provide the invisible portion information to the image signal processor 110 at an appropriate time point so as not to delay or interfere with the operation of the image signal processor 110. The CPU may set a threshold time considering the performance of the image signal processor 110 and determine a time point at which the invisible portion information is provided to the image signal processor 110 based on the threshold time.

According to some embodiments, the XR device 100 may include a GPU that performs graphic rendering to generate the graphic object image IMG_GO. According to some embodiments, the GPU may provide information about the graphic object image IMG_GO to the CPU and the CPU may generate the invisible portion information based on the provided information.

According to some embodiments, the XR device 100 may include a display processing unit (DPU) that generates the display picture DP_PIC based on the sensing data processed by the image signal processor 110 and the graphic object image IMG_GO generated by the GPU.

The image signal processor 110 according to some embodiments may prevent unnecessary image signal processing by considering the invisible portion IP of the real image IMG_R obscured by the graphic object image IMG_GO and skipping image signal processing on the data corresponding to the invisible portion IP. In this way, the image signal processor 110 may support low power-based image signal processing and the XR device 100 may efficiently manage power by minimizing the power for driving the image signal processor 110.

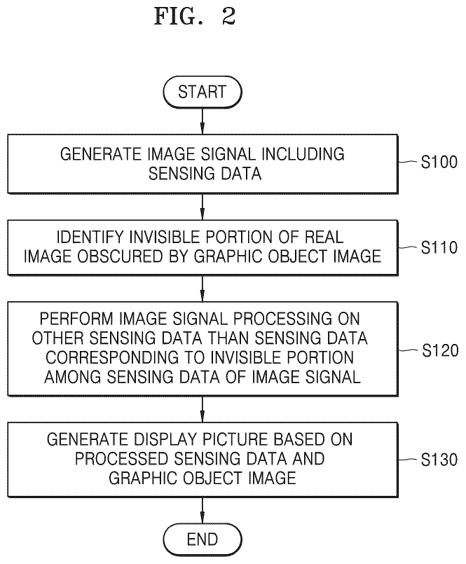

FIG. 2 is a flowchart of a method of operating an XR device according to some embodiments.

Referring to FIG. 2, in operation S100, the XR device may generate an image signal including sensing data. As a specific example, at least one camera included in the XR device may capture a place where the user of the XR device is looking (or a desired place) and generate an image signal including sensing data corresponding to the capturing result.

In operation S110, the XR device may identify an invisible portion of a real image obscured by a graphic object image. As a specific example, the CPU included in the XR device may generate invisible portion information based on at least one of object coordinate information corresponding to the graphic object image, object motion vector information corresponding to the graphic object image, and motion information of the XR device and the image signal processor included in the XR device may receive the invisible portion information from the CPU and identify the invisible portion of the real image. The CPU may receive the object coordinate information corresponding to the graphic object image and the object motion vector information corresponding to the graphic object image from the GPU. Additionally, the CPU may receive the motion information of the XR device from at least one sensor included in the XR device.

In operation S120, the XR device may perform image signal processing on other sensing data than sensing data corresponding to the invisible portion among the sensing data of the image signal. As a specific example, the image signal processor may skip image signal processing on data corresponding to the invisible portion, among the sensing data of the image signal, based on the invisible portion information provided from the CPU. To this end, the image signal processor may generate a bypass signal to bypass the sensing data corresponding to the invisible portion in the image signal processing based on the invisible portion information. In some embodiments, the image signal processor may convert data values corresponding to the invisible portion into specific values based on an invisible area filter included in the invisible portion information and exclude the same from the image signal processing.

In operation S130, the XR device may generate a display picture based on the sensing data processed in operation S120 and the graphic object image. As a specific example, the DPU included in the XR device may generate the display picture by compositing the sensing data processed by the image signal processor with the graphic object image generated by the GPU. The generated display picture may be output to the user of the XR device.

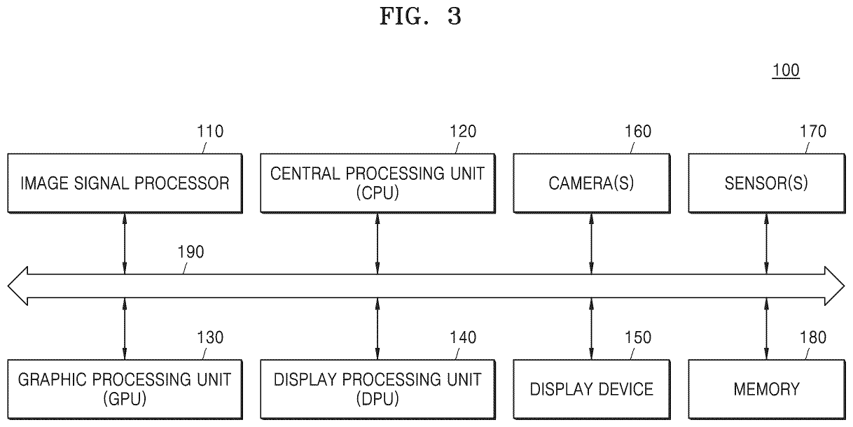

FIG. 3 is a schematic block diagram of an XR device 100 according to some embodiments.

Referring to FIG. 3, the XR device 100 includes an image signal processor 110, a CPU 120, a GPU 130, a DPU 140, a display device 150, camera(s) 160, sensor(s) 170, memory 180, and a bus 190. Herein, the image signal processor 110, the CPU 120, the GPU 130, and the DPU 140 may be referred to as processors. In some embodiments, the image signal processor 110, the CPU 120, the GPU 130, and DPU 140 may be integrated into one block or chip.

The image signal processor 110 may perform processing on image signals generated from the camera(s) 160. Herein, the processing on image signals may be referred to as image signal processing. For example, the image signal processor 110 may perform Bayer image processing, demosaic processing, denoising processing, and the like on the image signals.

The CPU 120 may perform overall control of the XR device 100 and may be referred to as a main processor. As an example, the CPU 120 may execute a certain application for driving the XR device 100 and perform data processing according to the executed application.

The GPU 130 may perform computing tasks, such as graphics rendering, machine learning, and video editing. As an example, the GPU 130 may generate a graphic object image according to an application running on the CPU 120.

The DPU 140 may generate a display picture by compositing the real image generated by the image signal processor 110 with the graphic object image generated by the GPU 130 and may output the display picture to the user of the XR device through the display device 150.

The display device 150 may include a display driver integrated circuit and a display panel to output the display picture received from the DPU 140 to the user.

The camera(s) 160 may be placed at a specific location within the XR device 100 and may include a plurality of image sensors. The camera(s) 160 may generate an image signal including sensing data generated through the plurality of image sensors and provide the image signal to the image signal processor 110.

The sensor(s) 170 may sense the movement of the XR device 100, the surrounding environment of the XR device 100, and the like.

The memory 180 may provide storage space required for processing of at least one of the image signal processor 110, the CPU 120, the GPU 130, and the DPU 140.

The bus 190 may provide a path for data to be transmitted and received between the components (i.e., 110 to 180) of the XR device 100.

According to some embodiments, the GPU 130 may generate the graphic object image and the image signal processor 110 may perform image signal processing on other sensing data than sensing data corresponding to the invisible portion among the sensing data of the image signal, based on the invisible portion information indicating the invisible portion of the real image obscured by the graphic object image. The DPU 140 may generate the display picture by compositing the graphic object image generated from the GPU 130 with the real image generated from the image signal processor 110 and may output the display picture through the display device 150.

According to some embodiments, the CPU 120 may generate the invisible portion information based on information about the graphic object image received from the GPU 130 and provide the invisible portion information to the image signal processor 110. As an example, the information about the graphic object image may include object coordinate information corresponding to the graphic object image and the CPU 120 may generate the invisible portion information based on the object coordinate information. As another example, the information about the graphic object image may include the object coordinate information corresponding to the graphic object image, object motion vector information corresponding to the graphic object image, and motion information about the movement of the XR device 100. The CPU 120 may generate the invisible portion information based on the object coordinate information, the object motion vector information, and the motion information.

According to some embodiments, the CPU 120 may set a threshold time to provide the invisible portion information to the image signal processor 110 at an appropriate time point. As an example, the CPU 120 may set the threshold time based on the performance of the image signal processor 110, the performance of the DPU 140, and the like and may provide the invisible portion information to the image signal processor 110 based on the set threshold time. Example embodiments of the threshold time are described below.

According to some embodiments, the CPU 120 may include hardware logic to perform the above-described operation or may perform the above-described operation by executing code stored in the memory 180.

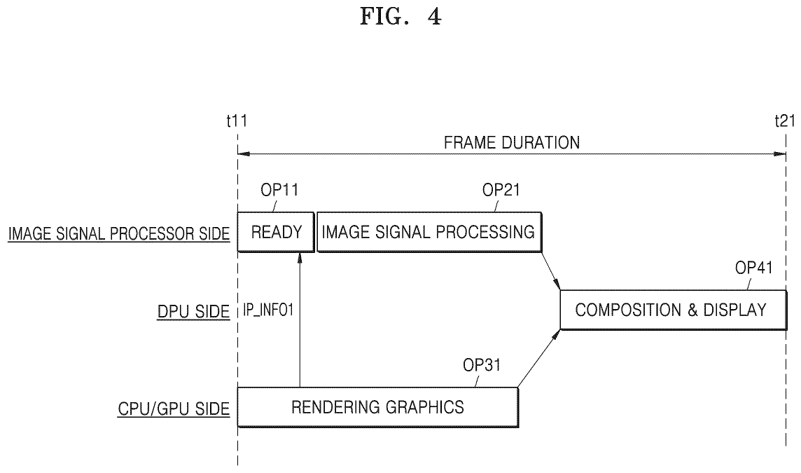

FIG. 4 is a diagram explaining an operation of an XR device according to some embodiments. In FIG. 4, the operation of each of the image signal processor, the DPU, the CPU, and the GPU included in the XR device is shown.

Referring to FIG. 4, a section between time t11 and time t21 may correspond to a frame duration, wherein the image signal processor, the DPU, and the CPU may perform operations to generate a display picture for each frame duration.

According to some embodiments, the image signal processor may perform a ready operation OP11 before image signal processing at time t11. The ready operation OP11 may include an operation of receiving an image signal including sensing data from the camera.

According to some embodiments, the GPU may perform a rendering operation OP31 to generate a graphic object image at time t11. Additionally, according to some embodiments, the CPU may receive information about the graphic object image from the GPU and generate invisible portion information IP_INFO based on the information about the graphic object image. The CPU may provide the invisible portion information IP_INFO to the image signal processor before starting an image signal processing operation OP21. In this way, the CPU may provide the invisible portion information IP_INFO to the image signal processor in advance at an appropriate time point so that the image signal processor can smoothly perform the image signal processing operation OP21.

According to some embodiments, the image signal processor may perform the image signal processing operation OP21 on other sensing data than sensing data corresponding to the invisible portion of the real image among the sensing data of the image signal based on the invisible portion information IP_INFO.

According to some embodiments, the DPU may perform a composition and display operation OP41 of compositing and displaying the real image generated by processing the sensing data from the image signal processor and the graphic object image generated from the GPU. Specifically, the DPU may generate a display picture by compositing the real image with the graphic object image and display the display picture using the display device.

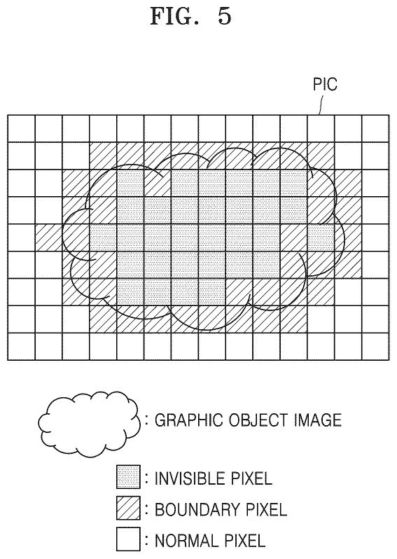

FIG. 5 is a diagram explaining invisible portion information according to some embodiments. FIG. 5 shows a picture PIC generated by an image signal processor and the picture PIC may be composed of a plurality of pixels.

Referring to FIG. 5, the picture PIC may include boundary pixels that are only partially visible because they overlap with the graphic object image, invisible pixels that are not visible because they are covered by the graphic object image, and normal pixels that do not overlap with the graphic object image.

According to some embodiments, the invisible portion information generated by the CPU may include first sub-information about the invisible pixels and second sub-information about the boundary pixels. As an example, the first sub-information may include an indicator indicating the invisible pixels and coordinate information of the invisible pixels and the second sub-information may include an indicator indicating the boundary pixels and coordinate information of the boundary pixels.

According to some embodiments, the image signal processor may skip image signal processing on the sensing data corresponding to the invisible pixels based on the first sub-information of the invisible portion information.

In some embodiments, the image signal processor may perform an image signal processing method for sensing data corresponding to the boundary pixels and an image signal processing method for sensing data corresponding to the normal pixels equally or differently. As a specific example, the image signal processor may perform image signal processing on the sensing data corresponding to the boundary pixels using a method in which some processing operations are skipped or a simpler calculation method than the sensing data corresponding to the normal pixels.

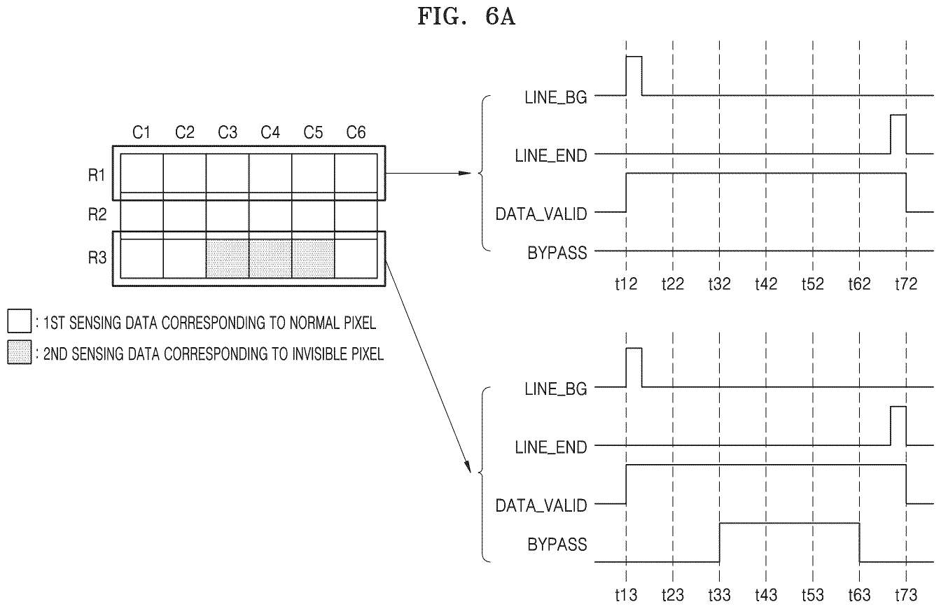

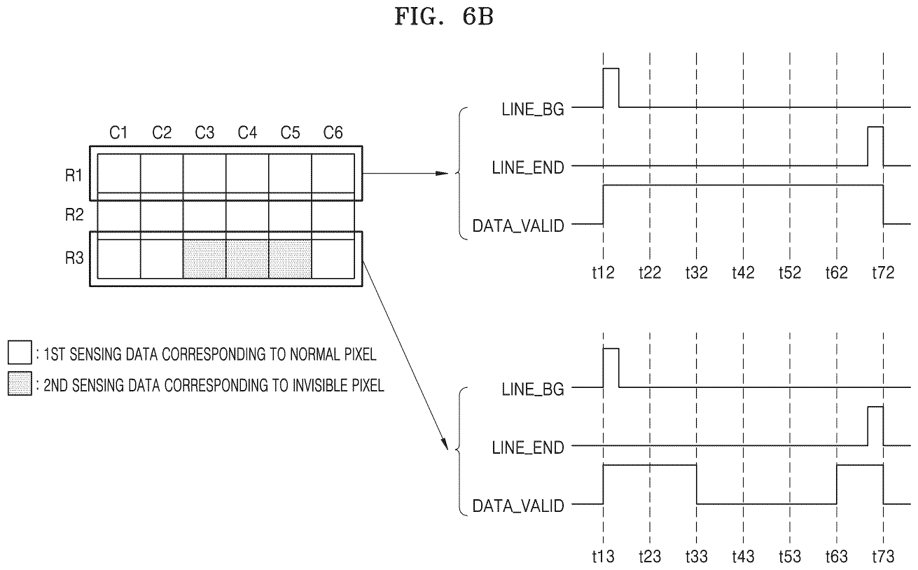

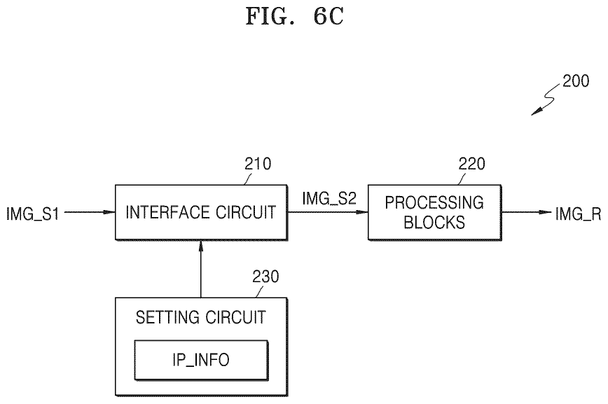

FIGS. 6A and 6B are diagrams explaining an image signal processing method according to some embodiments and FIG. 6C is a schematic block diagram of an image signal processor 200 that performs the method of FIGS. 6A and 6B. FIGS. 6A and 6B show signals generated from an image signal processor to process sensing data arranged in first to third row lines R1 to R3 and first to sixth column lines C1 to C6.

Referring to FIG. 6A, the image signal processor may generate a line start signal LINE_BG, a line end signal LINE_END, a data valid signal DATA_VALID, and a bypass signal BYPASS to process the sensing data. As an example, the image signal processor may sequentially process the sensing data in one row line direction in column order. Hereinafter, the sensing data corresponding to the normal pixels is referred to as first sensing data and the sensing data corresponding to the invisible pixels is referred to as second sensing data.

According to some embodiments, to process the first sensing data of the first row line R1 in the order of the first to sixth column lines C1 to C6, the image signal processor may generate the line start signal LINE_BG asserted to indicate the start of the first row line R1 at time t12, the data valid signal DATA_VALID asserted to indicate that the six first sensing data of the first row line R1 are valid from time t12 to time t72, the line end signal LINE_END asserted to indicate the end of the first row line R1 at time t72, and the disabled bypass signal BYPASS. The image signal processor may generate the signals LINE_BG, LINE_END, DATA_VALID, and BYPASS for the sensing data corresponding to the boundary pixels in the same manner as for the first sensing data.

According to some embodiments, to process the first and second sensing data of the third row line R3 in the order of the first to sixth column lines C1 to C6, the image signal processor may generate the line start signal LINE_BG asserted to indicate the start of the third row line R3 at time t13, the data valid signal DATA_VALID asserted to indicate that the first sensing data and the second sensing data of the third row line R3 are valid from time t13 to time t73, the line end signal LINE_END asserted to indicate the end of the third row line R3 at time t73, and the bypass signal BYPASS asserted from time t33 to time t63 corresponding to the second sensing data. That is, the image signal processor may confirm the second sensing data of the third row line R3 based on the bypass signal BYPASS and skip image signal processing on the second sensing data.

Referring further to FIG. 6B, the image signal processor may skip the image signal processing on the second sensing data by using the data valid signal DATA_VALID instead of the bypass signal BYPASS. For example, to process the first and second sensing data of the third row line R3 in the order of the first to sixth column lines C1 to C6, the image signal processor may generate the line start signal LINE_BG asserted to indicate the start of the third row line R3 at time t13, the data valid signal DATA_VALID asserted to indicate that the first sensing data of the third row line R3 is valid from time t13 to time t33 and from time t63 to time t73 and disabled to indicate that the second sensing data of the third row line R3 is not valid from time t33 to time t63, and the line end signal LINE_END asserted to indicate the end of the third row line R3 at time t73. The image signal processor may confirm the second sensing data of the third row line R3 based on the data valid signal DATA_VALID and may skip image signal processing on the second sensing data.

However, the embodiments of FIGS. 6A and 6B are only examples and are not limited thereto. The image signal processor may skip image signal processing through more diverse signals according to some embodiments.

With further reference to FIG. 6C, the image signal processor 200 includes an interface circuit 210, processing blocks 220, and a setting circuit 230.

According to some embodiments, the setting circuit 230 may store the invisible portion information IP_INFO received from the CPU. The setting circuit 230 may set certain parameters for generating the signals LINE_BG, LINE_END, DATA_VALID, and BYPASS of FIG. 6A or the signals LINE_BG, LINE_END, and DATA_VALID of FIG. 6B based on the invisible portion information IP_INFO.

According to some embodiments, the interface circuit 210 may receive a first image signal IMG_S1 including sensing data and generate a second image signal IMG_S2 based on the parameters set by the setting circuit 230 to provide the second image signal IMG_S2 to the image processing blocks 220. As an example, the second image signal IMG_S2 may include the signals LINE_BG, LINE_END, DATA_VALID, and BYPASS of FIG. 6A and the first image signal IMG_S1. As another example, the second image signal IMG_S2 may include the signals LINE_BG, LINE_END, and DATA_VALID of FIG. 6B and the first image signal IMG_S1.

According to some embodiments, as shown in FIG. 6A, the processing blocks 220 may skip image signal processing on the second sensing data corresponding to the invisible pixels based on the bypass signal BYPASS of the second image signal IMG_S2. In addition, according to some embodiments, as shown in FIG. 6B, the processing blocks 220 may skip image signal processing on the second sensing data corresponding to the invisible pixels based on the data valid signal DATA_VALID of the second image signal IMG_S2.

The processing blocks 220 may generate the real image IMG_R by performing image signal processing on the second image signal IMG_S2.

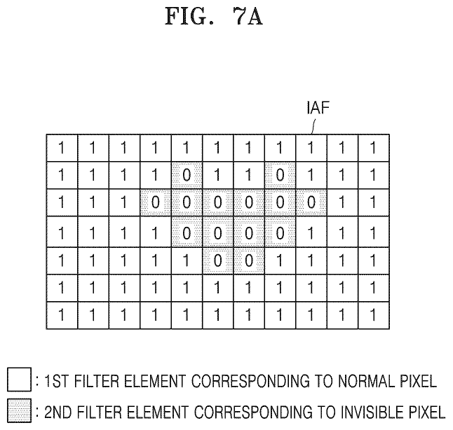

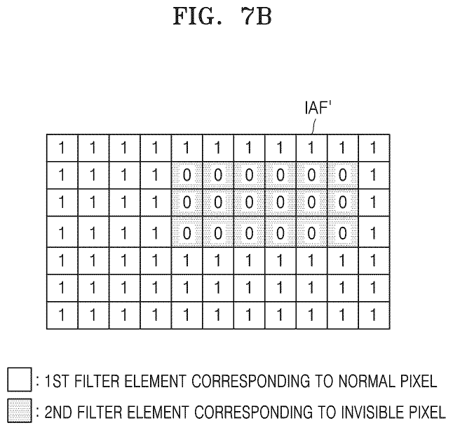

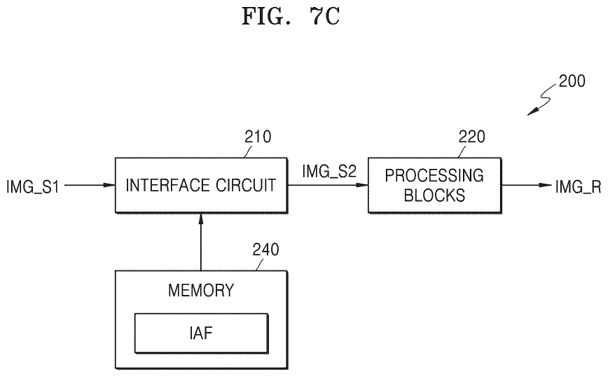

FIGS. 7A and 7B are diagrams explaining invisible area filters IAF and IAF′ used in image signal processing according to some embodiments and FIG. 7C is a schematic block diagram of an image signal processor 200 using the invisible area filters IAF and IAF′ of FIGS. 7A and 7B. The invisible area filters IAF and IAF′ of FIGS. 7A and 7B may be implemented as bit-map type filters. However, this is only an example and is not limited thereto. The invisible area filters may be implemented based on a plurality of coordinate collections that specifically represent the boundary points of the graphic object image or may be implemented based on the coordinates of a rectangular area including the graphic object image.

Referring to FIG. 7A, the invisible area filter IAF may include a first filter element corresponding to the normal pixels and a second filter element corresponding to the invisible pixels. The value of the first sensing data (i.e., sensing data corresponding to the normal pixels) passing through the first filter element may be maintained and the value of the second sensing data (i.e., sensing data corresponding to the invisible pixels) passing through the second filter element may be converted to 0. The second filter element of FIG. 7A may be placed on the invisible area filter IAF to have the shape of the graphic object image.

Referring further to FIG. 7B, the second filter element of the invisible area filter IAF′, unlike the invisible area filter IAF of FIG. 7A, may be placed on the invisible area filter IAF′ to have a rectangular shape including the graphic object image.

With further reference to FIG. 7C, the image signal processor 200 includes an interface circuit 210, processing blocks 220, and memory 240.

According to some embodiments, the memory 240 may store the invisible area filter IAF of the invisible portion information IP_INFO received from the CPU. That is, the CPU may generate the invisible area filter IAF and provide the generated invisible area filter IAF as the invisible portion information IP_INFO to the image signal processor 200. In some embodiments, the image signal processor 200 may use an invisible area filter stored in the memory 180 of FIG. 3.

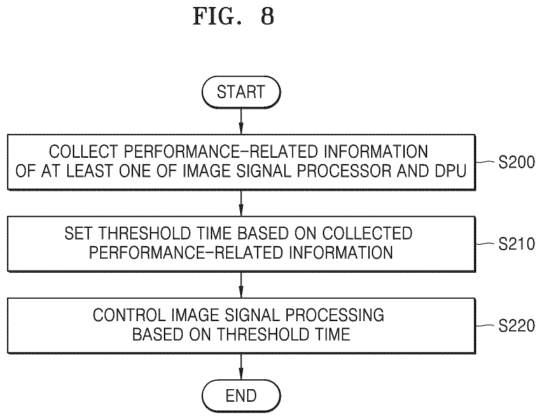

FIG. 8 is a flowchart of a method of operating a CPU according to some embodiments.

Referring to FIG. 8, in operation S200, the CPU may collect performance-related information of at least one of the image signal processor, the DPU, and the display device. According to some embodiments, the performance-related information may include the time required for image signal processing performed by the image signal processor for each frame duration and the time required for composition and display operations performed by the DPU for each frame duration. In some embodiments, the CPU may further collect information on the length of the frame duration and whether the operation of the image signal processor can be delayed.

In operation S210, the CPU may set a threshold time based on the performance-related information collected in operation S200. The threshold time may be related to a temporal condition under which the invisible portion information generated by the CPU in a specific frame duration must be provided to the image signal processor in the same frame duration. In other words, the threshold time may be a standard for determining whether the invisible portion information generated by the CPU in a specific frame duration is valid in the same frame duration.

In operation S220, the CPU may control image signal processing based on the threshold time set in operation S210. Specific details thereon are described below.

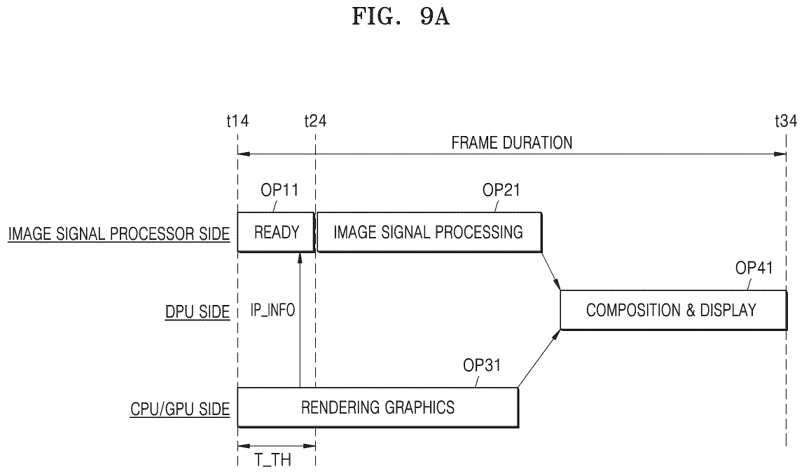

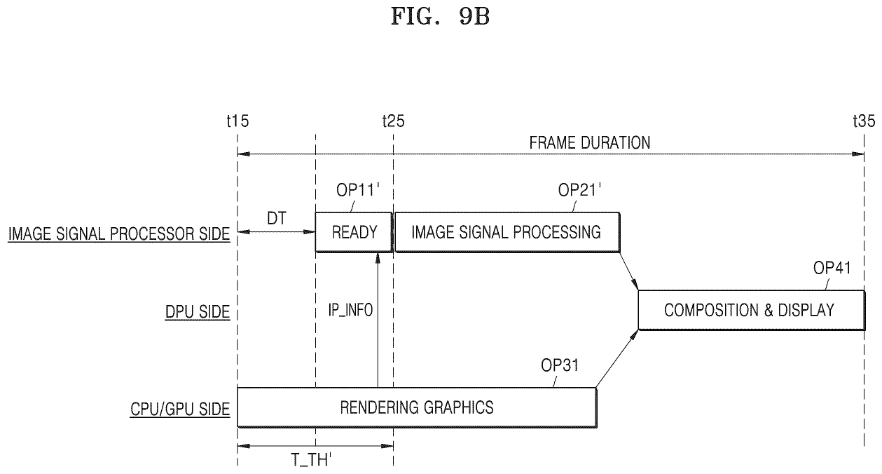

FIGS. 9A and 9B are diagrams explaining an operation of an XR device according to some embodiments. In FIGS. 9A and 9B, the operation of each of the image signal processor, the DPU, the CPU, and the GPU included in the XR device is shown.

Referring to FIG. 9A, a section between time t14 and time t34 may correspond to a frame duration, wherein the image signal processor, the DPU, and the CPU may perform operations to generate a display picture for each frame duration.

According to some embodiments, the image signal processor may perform a ready operation OP11 at time t14.

According to some embodiments, the GPU may perform a rendering operation OP31 to generate a graphic object image at time t14. According to some embodiments, the CPU may receive information about the graphic object image from the GPU and generate the invisible portion information IP_INFO based on the information about the graphic object image. In addition, the CPU may confirm whether the invisible portion information IP_INFO generated in the frame duration can be provided to the image signal processor within the threshold time T_TH and may provide the invisible portion information IP_INFO to the image signal processor when the invisible portion information IP_INFO can be provided. As an example, the sum of time t14, which is the start time point of the frame duration, and the threshold time T_TH, may be earlier than the time point when the image signal processing operation OP21 starts. The invisible portion information IP_INFO may be confirmed as valid information in the frame duration and may be provided to the image signal processor within the frame duration.

As described above with reference to FIG. 8, the threshold time T_TH may be set based on the length of the frame duration, the time required for the image signal processing operation OP21, and the time required for the composition and display operation OP41.

According to some embodiments, the image signal processor may perform the image signal processing operation OP21 on other sensing data than sensing data corresponding to the invisible portion of the real image among the sensing data of the image signal based on the invisible portion information IP_INFO.

According to some embodiments, the DPU may perform the composition and display operation OP41 of compositing and displaying the real image generated by processing the sensing data from the image signal processor and the graphic object image generated from the GPU. Specifically, the DPU may generate the display picture by compositing the real image and the graphic object image and may display the display picture using the display device.

Referring further to FIG. 9B, the operation of the image signal processor within the frame duration may be controlled by the CPU to be delayed by a certain delay time DT. Compared to FIG. 9A, the delay time DT may be additionally considered to set a threshold time T_TH′.

A section between time t15 and time t35 may correspond to a frame duration, wherein the image signal processor, the DPU, and the CPU may perform operations to generate a display picture for each frame duration.

According to some embodiments, the image signal processor may perform a ready operation OP11′ after a certain delay time DT from time t15.

According to some embodiments, the GPU may perform a rendering operation OP31 to generate a graphic object image at time t15. According to some embodiments, the CPU may receive information about the graphic object image from the GPU and generate invisible portion information IP_INFO based on the information about the graphic object image. In addition, the CPU may confirm whether the invisible portion information IP_INFO generated in the frame duration can be provided to the image signal processor within the threshold time T_TH′ and may provide the invisible portion information IP_INFO to the image signal processor when the invisible portion information IP_INFO can be provided. As an example, the sum of time t15, which is the start time point of the frame duration, and the threshold time T_TH′, may be earlier than the time point when the image signal processing operation OP21 starts.

Since the following content overlaps with FIG. 9A, detailed description thereof is omitted.

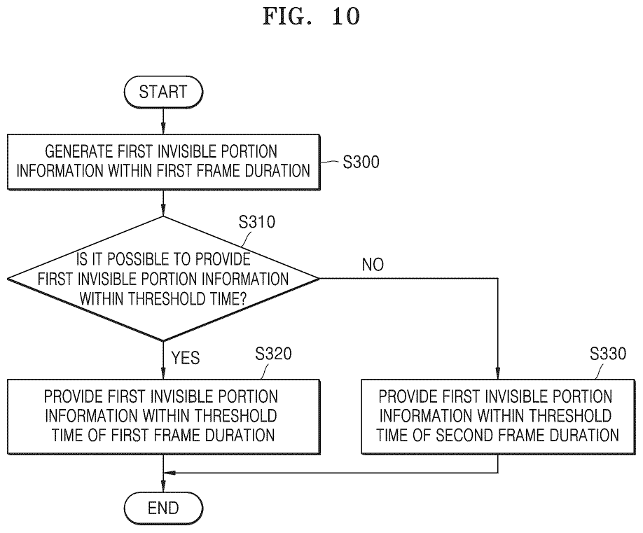

FIG. 10 is a flowchart of a method of operating a CPU according to some embodiments.

Referring to FIG. 10, in operation S300, the CPU may generate first invisible portion information within a first frame duration.

In operation S310, the CPU may determine whether the first invisible portion information can be provided to the image signal processor within a threshold time of the first frame duration. That is, the CPU may determine whether the first invisible portion information is valid in the first frame duration based on the threshold time.

When operation S310 is YES, the CPU may provide the first invisible portion information to the image signal processor within the threshold time of the first frame duration in following operation S320.

When operation S310 is NO, the CPU may provide the first invisible portion information to the image signal processor within the threshold time of the second frame duration in following operation S330.

The CPU may generate second invisible portion information even in the second frame duration and may provide the second invisible portion information to the image signal processor in the second frame duration so that the second invisible portion information can be used in a third frame duration following the second frame duration.

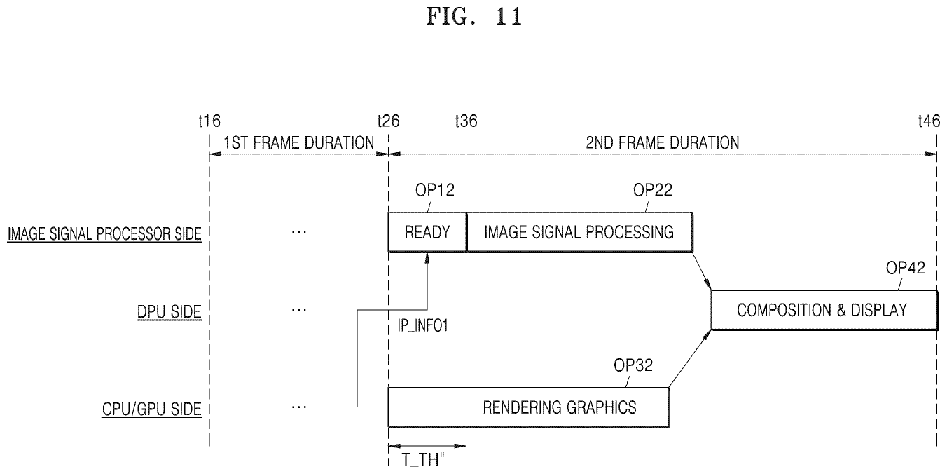

FIG. 11 is a diagram explaining an operation of an XR device according to some embodiments. In FIG. 11, the operation of each of the image signal processor, the DPU, the CPU, and the GPU included in the XR device is shown.

Referring to FIG. 11, a section between time t16 and time t26 may correspond to the first frame duration and a section between time t26 and time t46 may correspond to the second frame duration.

According to some embodiments, the CPU may generate first invisible portion information IP_INFO1 in the first frame duration and may determine that the first invisible portion information IP_INFO1 cannot be provided to the image signal processor within a threshold time of the first frame duration. That is, the first invisible portion information IP_INFO1 may not be valid in the first frame duration. The CPU may provide the first invisible portion information IP_INFO1 to the image signal processor before the threshold time T_TH″ of the second frame duration. That is, the CPU may provide the first invisible portion information IP_INFO1 to the image signal processor until time t36 before an image signal processing operation OP22 in the second frame duration. According to some embodiments, after correcting the first invisible portion information IP_INFO1 based on at least one of information related to a second graphic object image and motion information of the XR device, the CPU may provide the corrected first invisible portion information IP_INFO1 to the image signal processor before the threshold time T_TH″ in the second frame duration.

According to some embodiments, the image signal processor may perform the ready operation OP12 before image signal processing at time t26. The ready operation OP12 may include an operation of receiving a second image signal including sensing data from a camera.

According to some embodiments, the GPU may perform a rendering operation OP32 to generate the second graphic object image at time t26. Additionally, according to some embodiments, the CPU may receive information about the second graphic object image from the GPU and generate second invisible portion information based on the information about the second graphic object image. The second invisible portion information may be used in the third frame duration after the second frame duration.

According to some embodiments, the image signal processor may perform the image signal processing operation OP22 on other sensing data than sensing data corresponding to an invisible portion of a second real image among the sensing data of the second image signal based on the first invisible portion information IP_INFO1.

According to some embodiments, the DPU may perform a composition and display operation OP42 of compositing and displaying the second real image generated by processing the sensing data from the image signal processor and the second graphic object image generated from the GPU. Specifically, the DPU may generate a second display picture by compositing the second real image with the second graphic object image and display the second display picture using a display device.

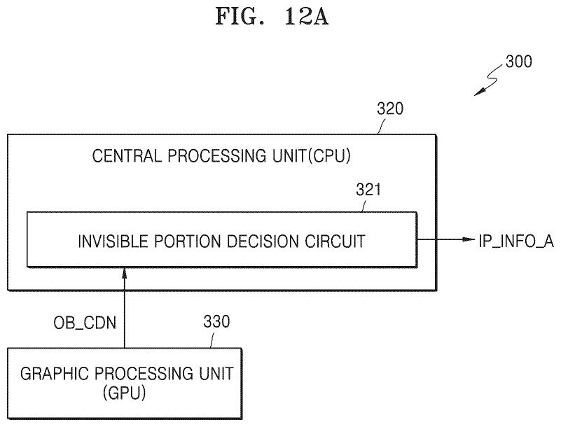

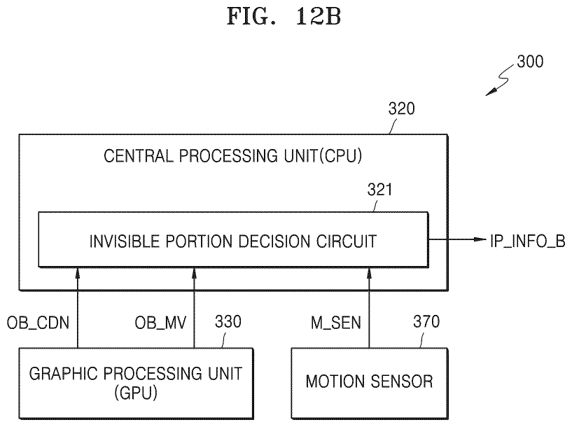

FIGS. 12A and 12B are schematic block diagrams of an XR device 300 according to some embodiments.

Referring to FIG. 12A, the XR device 300 includes a CPU 320 and a GPU 330, wherein the CPU 320 includes an invisible portion decision circuit 321.

According to some embodiments, the invisible portion decision circuit 321 may receive coordinate information OB_CDN for the graphic object image from the GPU 330. The invisible portion decision circuit 321 may generate invisible portion information IP_INFO_A based on the coordinate information OB_CDN.

With further reference to FIG. 12B, the XR device 300 includes a CPU 320, a GPU 330, and a motion sensor 370.

According to some embodiments, the invisible portion decision circuit 321 may receive the coordinate information OB_CDN for the graphic object image and object motion vector information OB_MV for the graphic object image from the GPU 330 and may receive motion information M_SEN indicating the movement of the XR device 300 from the motion sensor 370. The invisible portion decision circuit 321 may generate invisible portion information IP_INFO_B based on the coordinate information OB_CDN, the object motion vector information OB_MV, and the motion information M_SEN.

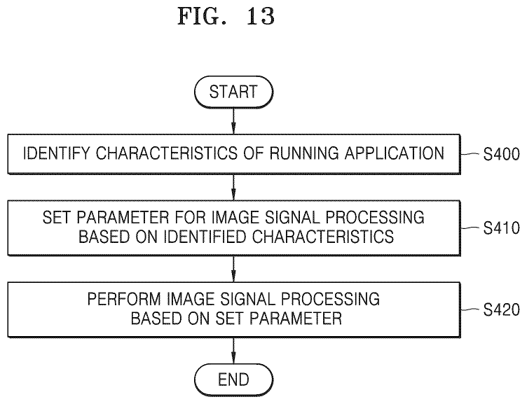

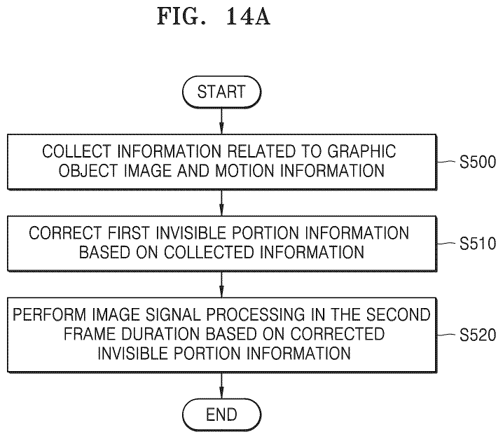

FIG. 13 is a flowchart of a method of operating an XR device according to some embodiments.

Referring to FIG. 13, in operation S400, the XR device may identify the characteristics of the running application. For example, the characteristics of the graphic object image rendered may be different for each type of application. As a specific example, the characteristics of the graphic object image may relate to the frequency of change in the position of the graphic object image in the display picture, the size of the change therein, and the like.

In operation S410, the XR device may set parameters for image signal processing based on the characteristics thereof identified in operation S400. According to some embodiments, the parameters may include parameters that set the information necessary to generate the invisible portion information. As a specific example, one of the method of generating the invisible portion information IP_INFO_A described with reference to FIG. 12A and the method of generating the invisible portion information IP_INFO_B described with reference to FIG. 12B may be selected depending on the setting of the corresponding parameters. In some embodiments, the parameters may include parameters related to setting a threshold time. As a specific example, the threshold time may be set to be long or short depending on the setting of the corresponding parameters.

In operation S420, the XR device may perform image signal processing based on the parameters set in operation S410. As a specific example, the CPU of the XR device may generate the invisible portion information based on the set parameters to provide the generated invisible portion information to the image signal processor or may set the threshold time based on the set parameters to provide the invisible portion information to the image signal processor of the XR device based on the set threshold time. The image signal processor may perform image signal processing based on the invisible portion information.

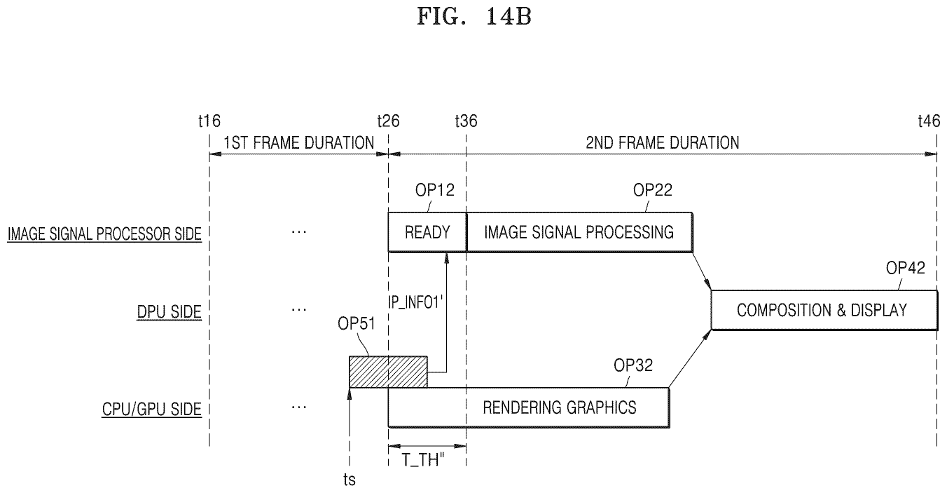

FIG. 14A is a flowchart of a method of operating an XR device according to some embodiments and FIG. 14B is a diagram specifically explaining FIG. 14A. In the description of FIG. 14B, parts thereof that overlap with FIG. 11 may be omitted.

Referring to FIG. 14A, in operation S500, the XR device may collect graphic object image-related information and motion information of the XR device. As an example, the graphic object image-related information may include object motion vector information for the graphic object image.

In operation S510, the XR device may correct the first invisible portion information generated in the first frame duration based on the collected information in operation S500.

In operation S520, the XR device may perform image signal processing in the second frame duration following the first frame duration based on the corrected first invisible portion information in operation S510.

Referring further to FIG. 14B, the CPU may correct the first invisible portion information IP_INFO1 generated at time ts in the first frame duration and may provide the corrected first invisible portion information IP_INFO1′ to the image signal processor before the threshold time T_TH″ in the second frame duration.

According to some embodiments, the CPU may perform an operation OP51 including an operation of collecting graphic object image-related information and motion information of XR device for a certain period from time ts and an operation of correcting the first invisible portion information IP_INFO1 based on the collected information. As an example, the graphic object image-related information may include information corresponding to the difference between the coordinate-based motion information of the graphic object image in the first frame duration and the coordinate-based motion information of the graphic object image in the second frame duration. Additionally, as an example, the graphic object image-related information may further include an amount of change in the object motion vector of the graphic object image between the first frame duration and the second frame duration. In some embodiments, the operation OP51 may be completed before the second frame duration begins, i.e., before t26.

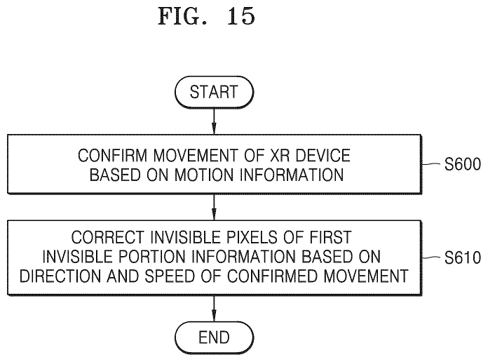

FIG. 15 is a flowchart of a method of correcting invisible portion information of a CPU according to some embodiments.

Referring to FIG. 15, in operation S600, the CPU may confirm the movement of the XR device based on the motion information of the XR device.

In operation S610, the CPU may correct the invisible pixels of the first invisible portion information based on the direction and speed of the confirmed movement thereof. In some embodiments, the CPU may correct the invisible pixels of the first invisible portion information based further on the difference between the coordinate-based motion information of the graphic object image in the current frame duration and the coordinate-based motion information of the graphic object image in the previous frame duration.

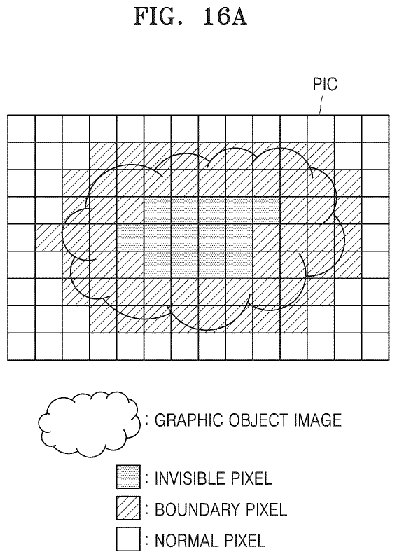

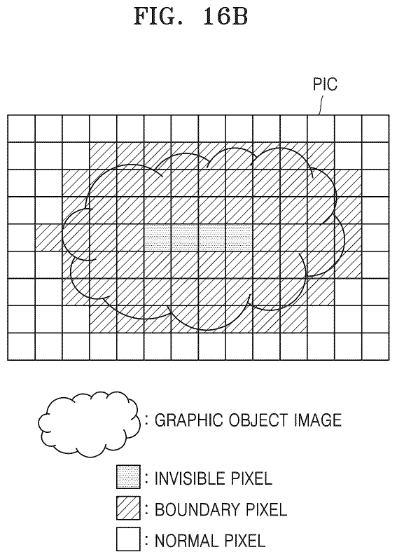

FIGS. 16A and 16B are diagrams explaining the corrected invisible portion information according to the method described with reference to FIG. 15. Hereinafter, it is assumed that the invisible portion information of FIG. 5 is the invisible portion information before correction in FIGS. 16A and 16B.

Referring to FIG. 16A, the CPU may correct the invisible portion information to include fewer invisible pixels than the total number of invisible pixels in the picture PIC of FIG. 5 based on the motion information of the XR device. As a specific example, the CPU may correct the invisible portion information so that some of the invisible pixels in the picture PIC of FIG. 5 are changed to the boundary pixels based on the direction (direction based on the X and Y axes) and the speed of the movement of the XR device.

Referring further to FIG. 16B, when the movement of the XR device at a faster speed than in FIG. 16A is confirmed, the CPU may correct the invisible portion information to include fewer invisible pixels than the total number of invisible pixels in the picture PIC of FIG. 16A.

The content described with reference to FIGS. 16A and 16B is only an example and is not limited thereto. The CPU may correct the invisible portion information in various ways in consideration of the motion information of the XR device.

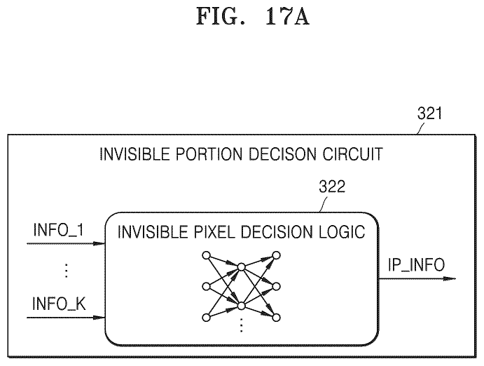

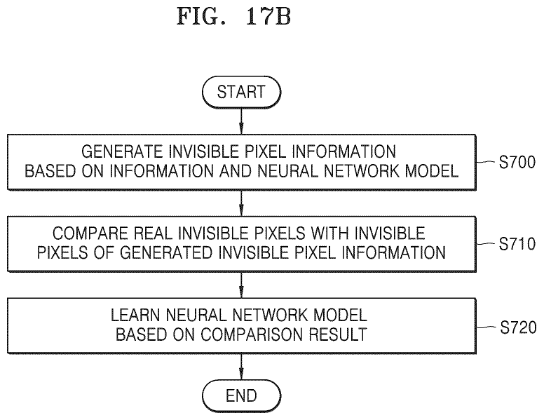

FIG. 17A is a block diagram of an invisible portion decision circuit 321 according to some embodiments and FIG. 17B is a flowchart of a method of learning an invisible pixel decision logic 322 of FIG. 17A.

Referring to FIG. 17A, the invisible portion decision circuit 321 includes the invisible pixel decision logic 322.

According to some embodiments, the invisible portion decision circuit 321 may include a neural network model, receive a plurality of pieces of information INFO_1 to INFO_K, and in response thereto, generate invisible pixel information IP_INFO using the neural network model. The invisible pixel information IP_INFO may correspond to the first sub-information described with reference to FIG. 5.

Referring further to FIG. 17B, in operation S700, the invisible portion decision circuit 321 may generate the invisible pixel information based on the plurality of pieces of information and the neural network model. The invisible portion decision circuit 321 may conservatively generate the invisible pixel information in consideration of the quality of the display picture.

In operation S710, the invisible portion decision circuit 321 may compare the invisible pixels of the generated invisible pixel information with actual invisible pixels in the display picture. In some embodiments, operation S710 may be performed by another circuit than the invisible portion decision circuit 321. In this case, the invisible portion decision circuit 321 may receive feedback including the performance result in operation S710 from the other circuit.

In operation S720, the invisible portion decision circuit 321 may learn the neural network model based on the comparison result in operation S710.

The invisible portion decision circuit 321 may complete the learned neural network model by repeatedly performing operations S700 to S720.

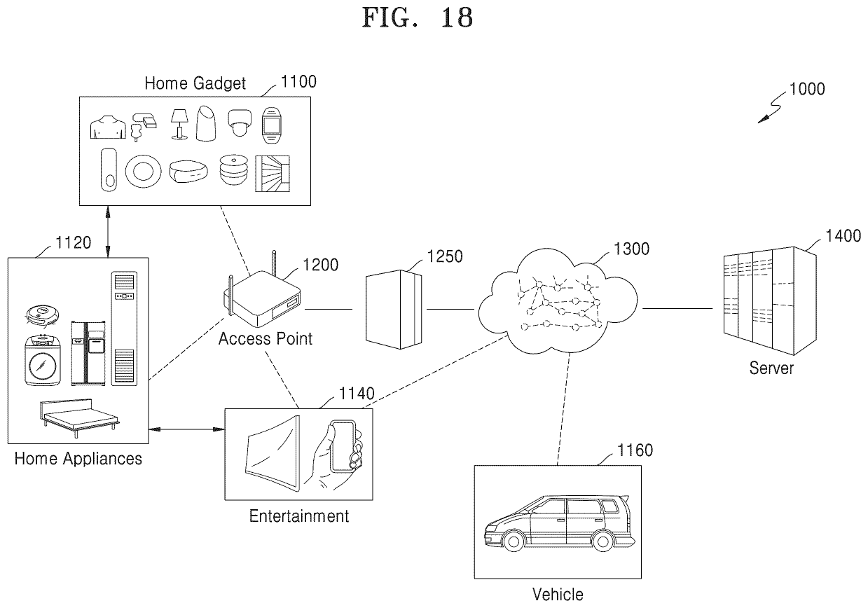

FIG. 18 is a conceptual diagram of an Internet of Things (IoT) network system 1000 to which embodiments are applied.

Referring to FIG. 18, the IoT network system 1000 includes a plurality of IoT devices 1100, 1120, 1140, and 1160, an access point 1200, a gateway 1250, a wireless network 1300, and a server 1400. The IT may refer to a network between things using wired/wireless communication.

The IoT devices 1100, 1120, 1140, and 1160 may be grouped according to the characteristics thereof. For example, the IoT devices may be grouped into a home gadget group 1100, a home appliance/furniture group 1120, an entertainment group 1140, or a vehicle group 1160. The plurality of IoT devices 1100, 1120, and 1140 may be connected to a communication network or to other IoT devices through the access point 1200. The access point 1200 may be built into one IoT device. The gateway 1250 may change the protocol to connect the access point 1200 to an external wireless network. The IoT devices 1100, 1120, and 1140 may be connected to the external communication network through the gateway 1250. The wireless network 1300 may include the Internet and/or a public network. The plurality of IoT devices 1100, 1120, 1140, and 1160 may be connected to the server 1400 that provides a certain service through the wireless network 1300 and the user may use the service through at least one of the plurality of IoT devices 1100, 1120, 1140, and 1160.

The XR technology may be applied to the plurality of IoT devices 1100, 1120, 1140, and 1160 may be applied and the plurality of IoT devices 1100, 1120, 1140, and 1160 may perform low power-based image signal processing according to some embodiments. Accordingly, the IoT devices 1100, 1120, 1140, and 1160 may provide effective XR services to the user.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the disclosure has been particularly shown and described with reference to embodiments thereof, it will be understood that various changes in form and details may be made therein without departing from the spirit and scope of the following claims.

What is claimed is:

1. A method of operating an extended reality (XR) device, the method comprising:
generating a first display picture in a first frame duration; and
generating a second display picture in a second frame duration,
wherein generating the first display picture comprises
generating first invisible portion information by determining a first invisible portion of a first real image obscured by a first graphic object image;
performing first image signal processing on first sensing data of a first image signal based on the first invisible portion information; and
generating the first display picture based on the processed first sensing data and the first graphic object image.

2. The method of claim 1, wherein the first invisible portion information comprises:
first sub-information about one or more boundary pixels overlapping with the first graphic object image; and
second sub-information about one or more invisible pixels covered by the first graphic object image.

3. The method of claim 1, wherein performing the first image signal processing comprises:
determining whether the first invisible portion information is valid in the first frame duration; and
in response to determining that the first invisible portion information is valid, performing the first image signal processing on sensing data other than sensing data corresponding to the first invisible portion information.

4. The method of claim 3, wherein performing the first image signal processing on the other sensing data comprises: generating a bypass signal to bypass the sensing data corresponding to the first invisible portion information in the first image signal processing.

5. The method of claim 1, wherein performing the first image signal processing on the other sensing data comprises: converting one or more values of the sensing data corresponding to the first invisible portion information into one or more specific values based on an invisible area filter.

6. The method of claim 3,
wherein the XR device comprises: a first processor configured to generate the first invisible portion information; and a second processor configured to perform the first image signal processing, and
wherein determining whether the first invisible portion information is valid comprises: determining whether the first invisible portion information from the first processor can be provided to the second processor within a threshold time.

7. The method of claim 6, wherein the first image signal processing starts later than a start time point of the first frame duration by at least the threshold time.

8. The method of claim 6, wherein the XR device further comprises a third processor configured to composite the processed first sensing data with the first graphic object image, and the threshold time is set based on at least one of the performance of the second processor, a performance of the third processor, or a length of the first frame duration.

9. The method of claim 3, wherein performing the first image signal processing further comprises performing the first image signal processing on the first sensing data in response to determining that the first invisible portion information is not valid.

10. The method of claim 3, wherein the first invisible portion information that is not valid in the first frame duration is used in generating the second display picture.

11. The method of claim 3,
wherein the first invisible portion information that is not valid in the first frame duration is corrected based on at least one of: information related to the first graphic object image, or motion information of the XR device, and
wherein the corrected first invisible portion information is used in generating the second display picture.

12. The method of claim 11, wherein a number of invisible pixels in the corrected first invisible portion information is less than a number of invisible pixels in the first invisible portion information.

13. The method of claim 1, wherein the first invisible portion information is generated based on at least one of: object coordinate information for the first graphic object image, object motion vector information for the first graphic object image, or motion information of the XR device.

14. The method of claim 1, further comprising: identifying characteristics of an application running on the XR device; and setting a parameter for the first image signal processing based on the identified characteristics.

15. The method of claim 14, wherein the parameter comprises at least one of: a first parameter related to information that forms a basis for generating the first invisible portion information; or a second parameter related to information that forms a basis for determining whether the first invisible portion information is valid in the first frame duration.

16. An extended reality (XR) device comprising:
a first processor configured to generate a first graphic object image in a first frame duration;
a second processor configured to perform, based on first invisible portion information indicating a first invisible portion of a first real image obscured by the first graphic object image, first image signal processing on sensing data of a first image signal in the first frame duration, wherein the sensing data is different from sensing data corresponding to the first invisible portion; and
a third processor configured to generate a display picture based on the first graphic object image and the sensing data processed by the first image signal processing.

17. The XR device of claim 16, further comprising a fourth processor configured to generate the first invisible portion information in the first frame duration and provide the first invisible portion information to the second processor within a threshold time.

18. The XR device of claim 16, further comprising a fourth processor configured to generate the first invisible portion information in a frame duration before the first frame duration and provide the first invisible portion information to the second processor within a threshold time.

19. The XR device of claim 18, wherein the first invisible portion information is corrected based on movement of the XR device sensed for a certain period from a generation time point of the first invisible portion information, and wherein, after correction, the first invisible portion information is provided to the second processor.

20. A method of operating an extended reality (XR) device, the method comprising:
determining an invisible portion of a real image obscured by a graphic object image;
performing image signal processing on sensing data other than sensing data corresponding to the invisible portion among sensing data of an image signal; and
generating a display picture based on the sensing data processed by the image signal processing and the graphic object image.
